(19) United States
(12) Patent Application Publication
(10) Pub. No.: US 2013/0017916 A1
(43) Pub. Date: Jan. 17, 2013

(54) VEHICLE DRIVE DEVICE

(71) Applicants: Natsuki Sada, Anjo (JP); Hidetoshi Aoki, Anjo (JP); Michitaka Tsuchida, Miyoshi (JP)

(72) Inventors: Natsuki Sada, Anjo (JP); Hidetoshi Aoki, Anjo (JP); Michitaka Tsuchida, Miyoshi (JP)

(73) Assignees: TOYOTA JIDOSHA KABUSHIKI KAISHA, Toyota-shi (JP); AISIN AW CO., LTD., Anjo-shi (JP)

(21) Appl. No.: 13/546,428

(22) Filed: Jul. 11, 2012

(30) Foreign Application Priority Data
Jul. 11, 2011 (JP) 2011-153023

(51) Int. Cl. F16H 37/08

(52) U.S. Cl. 475/5; 903/902; 180/65.22

(57) ABSTRACT

A vehicle drive device includes an input member drivingly coupled to a drive output member of an internal combustion engine that rotates in a positive direction; an output member drivingly coupled to wheels; a rotating electrical machine; a distribution output member drivingly coupled to the output member; and a differential gear unit that distributes and transfers a torque, transferred to the input member, to the rotating electrical machine and the distribution output member. The distribution output member is placed coaxially with the input member and supported in a radial direction by a support bearing so as to be capable of rotating. Rotation of the input member in a negative direction is restricted by a one-way clutch. The one-way clutch is placed radially inward of the support bearing. At least a part of the one-way clutch is placed so as to overlap the support bearing as viewed in the radial direction.

### INCORPORATION BY REFERENCE

The disclosure of Japanese Patent Application No. 2011-153023 filed on Jul. 11, 2011 including the specification, drawings and abstract is incorporated herein by reference in its entirety.

### BACKGROUND OF THE INVENTION

The present invention relates to vehicle drive devices that include an input member drivingly coupled to a drive output member of an internal combustion engine that rotates in a positive direction, an output member drivingly coupled to wheels, a rotating electrical machine, a distribution output member drivingly coupled to the output member, and a differential gear unit that distributes and transfers a torque, transferred to the input member, to the rotating electrical machine and the distribution output member.

### Description of the Related Art

Related art of such vehicle drive devices includes an art described in, e.g., the following Japanese Patent Application Publication No. 2002-12046 (JP 2002-12046 A). JP 2002-12046 A describes a configuration in which a differential gear unit is formed by a planetary gear mechanism having three rotating elements, a first rotating electrical machine is drivingly coupled to a sun gear, an input member is drivingly coupled to a carrier, and a second rotating electrical machine and an output member are drivingly coupled to a ring gear. This vehicle drive device includes a one-way clutch that restricts negative rotation of the carrier and the input member that are drivingly coupled so as to rotate together, and has a drive mode in which, while restricting the negative rotation of the carrier and the input member, the one-way clutch receives a reaction force of a torque of the first rotating electrical machine and transfers the torque of the first rotating electrical machine to the output member to move the vehicle.

In the related art, however, as shown in FIG. 2 of JP 2002-12046 A, the one-way clutch is placed at a different position in an axial direction from the differential gear unit and the output member. Accordingly, the overall axial length of the vehicle drive device is increased by at least an amount corresponding to the axial length of the one-way clutch.

### SUMMARY OF THE INVENTION

Accordingly, it is desired to implement a vehicle drive device capable of suppressing an increase in overall axial length of the device even if the device includes an one-way clutch that restricts negative rotation of an input member.

A vehicle drive device according to a first aspect of the present invention includes: an input member drivingly coupled to a drive output member of an internal combustion engine that rotates in a positive direction; an output member drivingly coupled to wheels; a rotating electrical machine; a distribution output member drivingly coupled to the output member; and a differential gear unit that distributes and transfers a torque, transferred to the input member, to the rotating electrical machine and the distribution output member. The distribution output member is placed coaxially with the input member, and is supported in a radial direction by a support bearing so as to be capable of rotating, rotation of the input member in a negative direction is restricted by a one-way clutch, the one-way clutch is placed radially inward of the support bearing; and at least a part of the one-way clutch is placed so as to overlap the support bearing as viewed in the radial direction.

In the present application, regarding the direction of rotation and torque of each member, the “positive direction” refers to the same direction as the rotation direction in association with rotation of the drive output member of the internal combustion engine, the “negative direction” refers to the opposite direction thereto. If the rotational speed of each member is “positive,” it means that each member is rotating in the positive direction. If the rotational speed of each member is “negative,” it means that each member is rotating in the negative direction. If the rotational speed of each member is “zero,” it means that rotation of each member is stopped.

In the present application, the expression “drivingly coupled” refers to the state in which two rotating elements are coupled together so as to be able to transmit a driving force therebetween, and is used as a concept including the state in which the two rotating elements are coupled together so as to rotate together, or the state in which the two rotating elements are coupled together so as to be able to transmit the driving force therebetween via one or more transmission members. Such transmission members include various members that transmit rotation at the same speed or at a shifted speed, and include, e.g., a shaft, a gear mechanism, a belt, a chain, etc. Such transmission members may include an engagement element that selectively transmits rotation and a driving force, such as a friction engagement element, a dog engagement element, etc. However, if the expression “drivingly coupled” is used for each rotating element of a differential gear unit, it refers to the state in which three or more rotating elements included in the differential gear unit are drivingly coupled with no other rotating elements interposed therebetween.

In the present application, a differential gear mechanism including three rotating elements, such as a planetary gear mechanism including a sun gear, a carrier, and a ring gear, is used, and this differential gear mechanism itself or a device obtained by combining a plurality of differential gear mechanisms is referred to as the “differential gear unit.”

In the present application, the “rotating electrical machine” is used as a concept including a motor (an electric motor), a generator (an electric generator), and a motor-generator that functions both as the motor and the generator as necessary.

In the present application, regarding arrangement of two members, the expression “overlap as viewed in a predetermined direction” means that when the predetermined direction is a viewing direction and a viewing point is shifted in each direction perpendicular to the viewing direction, the viewing point from which the two members are seen to overlap each other is present at least in a region.

According to the first aspect, negative rotation of the input member can be restricted by the one-way clutch, and with the negative rotation of the input member being restricted, an output torque of the rotating electrical machine can be transferred to the output member via the differential gear unit. This allows electric running using only the output torque of the rotating electrical machine to be achieved in, e.g., a hybrid vehicle using the vehicle drive device of the present application. Moreover, the one-way clutch is placed radially inward of the support bearing so that at least a part of the one-way clutch overlaps the support bearing as viewed in the radial direction. Thus, the one-way clutch can be placed by using a space that is formed radially inward of in order to place the support bearing therein, whereby an increase in overall axial length of the vehicle drive device can be suppressed.

The distribution output member may be formed in a cylindrical shape, the entire differential gear unit may be placed radially inward of the distribution output member so as to overlap the distribution output member as viewed in the radial direction, a pair of distribution support bearings may be provided which are placed radially inward of the distribution output member on both sides in an axial direction with respect to the differential gear unit, and which support the distribution output member from radially inward of so as to be capable of rotating, and one of the pair of distribution support bearings may be the support bearing.

According to this configuration, one of the pair of distribution support bearings placed on both sides in the axial direction of the distribution output member and at least a part of the one-way clutch are placed radially inward of the distribution output member formed in the cylindrical shape, so as to overlap each other as viewed in the radial direction. The entire differential gear unit is placed radially inward of the distribution output member at a position overlapping the distribution output member as viewed in the radial direction. This can reduce the space in the axial direction that is occupied by the distribution output member, the differential gear unit, the support bearing, and the one-way clutch. Thus, an increase in overall axial length of the vehicle drive device including the differential gear unit can be suppressed.

The vehicle drive device may further include: a support wall extending in the radial direction on an opposite side in the axial direction from the differential gear unit with respect to the support bearing; and an input support bearing that supports the input member from radially outside so as to be capable of rotating, the support wall may include a first opposing surface that faces toward the differential gear unit in the axial direction, an inner race of the one-way clutch may include a second opposing surface that faces toward the support wall in the axial direction, and the input support bearing may be placed between the first opposing surface and the second opposing surface in the axial direction so as to be in contact with both the first opposing surface and the second opposing surface.

According to this configuration, the input member is supported in the radial direction by the input support bearing, and is supported in the axial direction by the first opposing surface and the second opposing surface. Thus, according to this configuration, the input member can be supported in both the axial direction and the radial direction while suppressing an increase in axial length of the vehicle drive device, which is caused by adding the one-way clutch.

It is preferable that the inner race of the one-way clutch is formed integrally with the input member.

According to this configuration, the number of parts of the vehicle drive device can be reduced as compared to the case where the inner race of the one-way clutch is provided separately. This facilitates reduction in size and cost of the vehicle drive device.

The inner race of the one-way clutch may be spline fitted on an outer peripheral surface of the input member, the input member may include an internal oil passage formed in the input member, and an outer peripheral opening that communicates with the internal oil passage and that opens in the outer peripheral surface of the input member, the outer peripheral opening may be placed at a position overlapping the inner race as viewed in the radial direction, a differential gear unit-side gap, which is a gap between an inner peripheral surface of an end on a side where the differential gear unit is formed in the axial direction of the inner race and the outer peripheral surface of the input member may serve as an oil supply portion to the differential gear unit, and an oil passage that extends through the inner race in the radial direction on an opposite side in the axial direction from the differential gear unit-side gap with respect to the outer peripheral opening may serve as an oil supply portion to a sliding portion of the one-way clutch.

According to this configuration, oil supplied from the internal oil passage formed in the input member can be properly supplied to the differential gear unit and the sliding portion of the one-way clutch by merely providing one outer peripheral opening in the input member. Since the inner race is spline fitted on the input member, clearance provided in the spline fitting portion can reduce a shock that is transmitted from the input member to the one-way clutch when the input member is subjected to a shock.

### BRIEF DESCRIPTION OF THE DRAWINGS

FIG. 1 is a skeleton diagram showing a vehicle drive device according to an embodiment of the present invention;

FIG. 2 is a cross-sectional view showing a main part in a plane perpendicular to an axial direction of the vehicle drive device according to the embodiment of the present invention;

FIG. 3 is an enlarged view showing the main part in the plane perpendicular to the axial direction of the vehicle drive device according to the embodiment of the present invention;

FIG. 4 is a cross-sectional view showing a main part in a plane perpendicular to an axial direction of a vehicle drive device according to an embodiment of the present invention; and

FIG. 5 is a cross-sectional view showing a main part in a plane perpendicular to the axial direction of the vehicle drive device according to an embodiment of the present invention.

### DETAILED DESCRIPTION OF THE EMBODIMENTS

### 1. First Embodiment

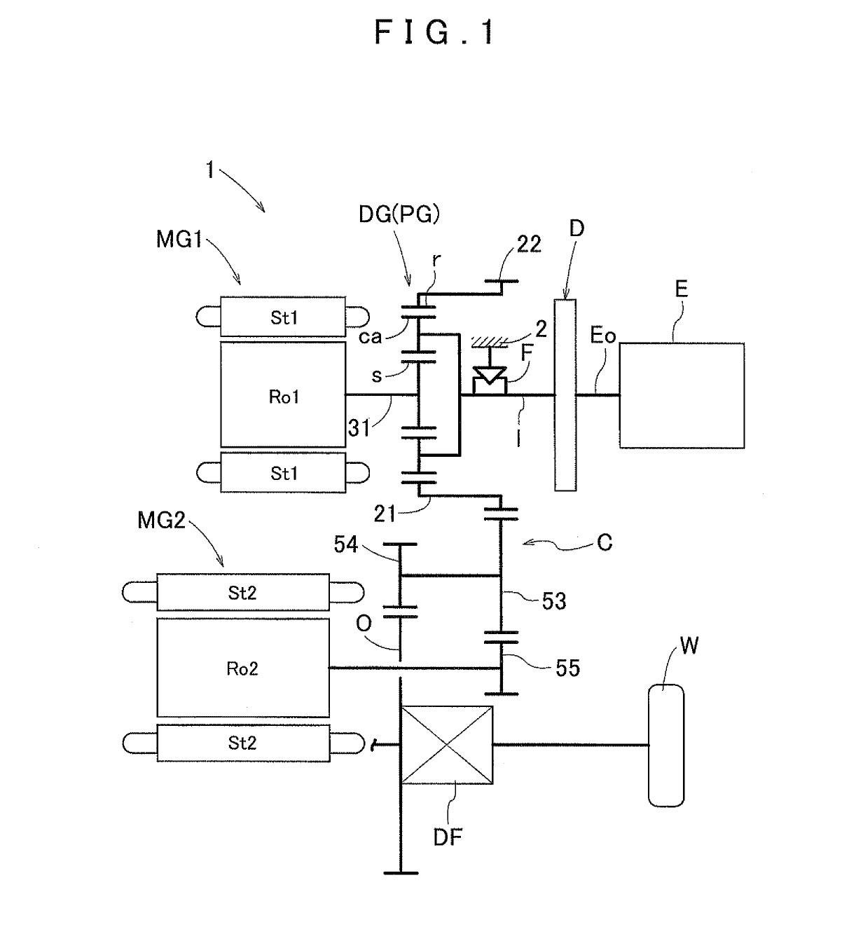

An embodiment of a vehicle drive device according to the present invention will be described below with reference to the accompanying drawings. As shown in FIG. 1, a vehicle drive device 1 according to the embodiment is a drive device (a drive device for hybrid vehicles) that drives a vehicle (a hybrid vehicle) including both an internal combustion engine E and rotating electrical machines MG1, MG2 as driving force sources of wheels W.

1-1. Overall Configuration of Vehicle Drive Device

First, the overall configuration of the vehicle drive device 1 according to the present embodiment will be described. The vehicle drive device 1 includes: an input member I that is drivingly coupled to the internal combustion engine E; an output member O that is drivingly coupled to the wheels W; the first rotating electrical machine MG1; a distribution output member 21 drivingly coupled to the output member O; and a differential gear unit DG that distributes and transfers a torque, transferred to the input member I, to the first rotating electrical machine MG1 and the distribution output member 21. In the present embodiment, the vehicle drive device 1 further includes the second rotating electrical machine MG2 that is drivingly coupled to the output member O, and the second rotating electrical machine MG2 and the output member O are drivingly coupled to the distribution output member 21. Thus, the differential gear unit DG is configured to be able to distribute the output torque of the internal combustion engine E, transferred to the input member I, toward the first rotating electrical machine MG1 and to the output member O (the wheels W) and the second rotating electrical machine MG2. That is, the vehicle drive device 1 according to the present embodiment is configured as a so-called 2-motor split type drive device for hybrid vehicles.

In the present embodiment, the first rotating electrical machine MG1 corresponds to the “rotating electrical machine” in the present application.

Note that in the following description, the “axial direction,” the “circumferential direction,” and the “radial direction” are described based on the central axis of the input member I unless otherwise specified.

The differential gear unit DG has at least three rotating elements. As shown in FIG. 1, in the present embodiment, the differential gear unit DG is formed by a single-pinion type planetary gear mechanism PG That is, the differential gear unit DG has a sun gear s, a carrier ca, and a ring gear r. As described below, the input member I, the distribution output member 21, and the first rotating electrical machine MG1 are drivingly coupled to the different rotating elements of the differential gear unit DG, with none of the other rotating elements of the differential gear unit DG interposed therebetween. In this example, the first rotating electrical machine MG1 is drivingly coupled to the sun gear s, the input member I is drivingly coupled to the carrier ca, and the distribution output member 21 is drivingly coupled to the ring gear r. The output member O and the second rotating electrical machine MG2 are drivingly coupled to the distribution output member 21 via a counter gear mechanism C described below. Thus, the output member O and the second rotating electrical machine MG2 are drivingly coupled to the ring gear r of the differential gear unit DG with none of the other rotating elements of the differential gear unit DG interposed therebetween.

The input member I is drivingly coupled to the internal combustion engine E. In the present embodiment, the input member I is a shaft member (an input shaft). The internal combustion engine E is a motor that outputs power by fuel combustion. For example, a spark ignition engine such as a gasoline engine, a compression ignition engine such as a diesel engine, etc. can be used as the internal combustion engine E. In the present embodiment, the input member I is drivingly coupled to a drive output member Eo such as a crankshaft of the internal combustion engine E via a damper D. It is also preferable that the input member I be drivingly coupled to the drive output member Eo via a clutch etc. in addition to the damper D, or be directly drivingly coupled to the drive output member Eo with none of the damper D, the clutch, etc. interposed therebetween.

The output member O is drivingly coupled to the wheels W. In the present embodiment, the output member O is a gear member. Specifically, the output member O is a differential input gear provided in an output differential gear unit DF. In the present embodiment, the output differential gear unit DF is formed by a differential gear mechanism using bevel gears that mesh with each other, and distributes a torque, which is transferred to the output member O, to the right and left wheels W as driving wheels.

The first rotating electrical machine MG1 has a first stator SU fixed to a case 2, and a first rotor Ro1 rotatably supported radially inward of the first stator St1. The first rotor Ro1 is drivingly coupled to the sun gear s of the differential gear unit DG via a first rotor shaft 31 having the first rotor Ro1 fixed thereto, so as to rotate together with the sun gear s. The second rotating electrical machine MG2 has a second stator St2 fixed to the case 2, and a second rotor Ro2 rotatably supported radially inward of the second stator St2. The second rotor Ro2 is drivingly coupled to a second rotating electrical machine output gear 55 via a second rotor shaft having the second rotor Ro2 fixed thereto, so as to rotate together with the second rotating electrical machine output gear 55.

Each of the rotating electrical machines MG1, MG2 is electrically connected to an electricity storage device, not shown. A battery, a capacitor, etc. can be used as the electricity storage device. In the present embodiment, each of the first rotating electrical machine MG1 and the second rotating electrical machine MG2 is capable of functioning as a motor (an electric motor) that is supplied with electric power from the electricity storage device to generate power (torque), and as a generator that is supplied with power to generate electric power and to supply the generated electric power to the electricity storage device.

The vehicle drive device 1 further includes a one-way clutch F. The one-way clutch F is provided between the case 2 and the input member I so as to allow the input member I and the carrier ca to rotate only in a positive direction relative to the case 2. The case 2 is a non-rotating member fixed to the body of the vehicle on which the vehicle drive device 1 is mounted, and the rotational speed of the case 2 is always zero. Thus, in the present embodiment, the one-way clutch F is provided to allow the input member I to rotate positively (to rotate in the positive direction), and to restrict negative rotation (rotation in a negative direction) of the input member I. Thus, regarding the carrier ca that rotates together with the input member I, rotation in the negative direction is similarly restricted by the one-way clutch F. In the following description, the “negative-rotation restricting state” refers to the state in which the negative rotation of the carrier ca is actually being restricted. On the other hand, the “relative rotation state” refers to the state in which rotation of the carrier ca is not being restricted and the carrier ca is rotating in the positive direction. In the negative-rotation restricting state, the carrier ca and the input member I, which rotate together, are held stationary with respect to the case 2, and the respective rotational speeds of the carrier ca and the input member I are zero.

The second rotating electrical machine MG2 and the output member O are drivingly coupled to the ring gear r via the counter gear mechanism C and the distribution output member 21. As shown in FIG. 1, the counter gear mechanism C is configured to have a first counter gear 53, a second counter gear 54, and a counter shaft that couples the first and second counter gears 53, 54 so that the first and second counter gears 53, 54 rotate together. The distribution output member 21 has an output gear 22 that meshes with the first counter gear 53. The second rotating electrical machine output gear 55 is placed so as to mesh with the first counter gear 53 at a different position in a circumferential direction (a circumferential direction of the first counter gear 53) from a position where the first counter gear 53 meshes with the output gear 22, so that the second rotating electrical machine MG2 is drivingly coupled to the ring gear r. The output member O is placed so as to mesh with the second counter gear 54, and thus is drivingly coupled to the ring gear r.

With the above configuration, the vehicle drive device 1 is capable of executing an electric drive mode in which the vehicle is moved only by the output torques of the rotating electrical machines MG1, MG2. In the present embodiment, the electric drive mode includes two modes, namely a first electric drive mode and a second electric drive mode.

The first electric drive mode is a drive mode in which the output member O is driven only by the output torque of the second rotating electrical machine MG2 with the one-way clutch F being in the relative rotation state. In the first electric drive mode, the internal combustion engine E is brought into a combustion stop state in which combustion is stopped. That is, in the first electric drive mode, no torque is transferred via the sun gear s and the input member 1, and only the torque of the second rotating electrical machine MG2 that is drivingly coupled to the ring gear r is transferred to the output member O that is also drivingly coupled to the ring gear r. The second rotating electrical machine MG2 outputs a torque according to a requested driving force to move the vehicle.

The second electric drive mode is a drive mode in which the vehicle runs at least by the output torque of the first rotating electrical machine MG1 with the one-way clutch F being in the negative-rotation restricting state. In the present embodiment, the second electric drive mode is a drive mode in which the internal combustion engine E is brought into the combustion stop state and the output member O is driven by the torques of both the first rotating electrical machine MG1 and the second rotating electrical machine MG2. Accordingly, in the second electric drive mode, the torque of the second rotating electrical machine MG2 that is drivingly coupled to the ring gear r is transferred to the output member O that is also drivingly coupled to the ring gear r. With the rotational speed of the carrier ca being zero and with the one-way clutch F being in the negative-rotation restricting state, the first rotating electrical machine MG1 rotates negatively and outputs a torque in the negative direction.

The one-way clutch F in the negative-rotation restricting state holds the input member I and the carrier ca stationary with respect to the case 2. Thus, the one-way clutch F functions as an element that receives a reaction force of the torque of the first rotating electrical machine MG1, and the torque in the negative direction of the first rotating electrical machine MG1, which is transferred to the sun gear s, is reversed in direction and transferred to the output member O drivingly coupled to the ring gear r. Thus, the first rotating electrical machine MG1 and the second rotating electrical machine MG2 operate together to output a torque according to a requested driving force, thereby moving the vehicle. In the second electric drive mode, the torque of the first rotating electrical machine MG1 can also be used in addition to the torque of the second rotating electrical machine MG2, and thus a relatively large torque can be transferred to the wheels W to move the vehicle.

1-2. Mechanical Configuration of Each Part of Vehicle Drive Device

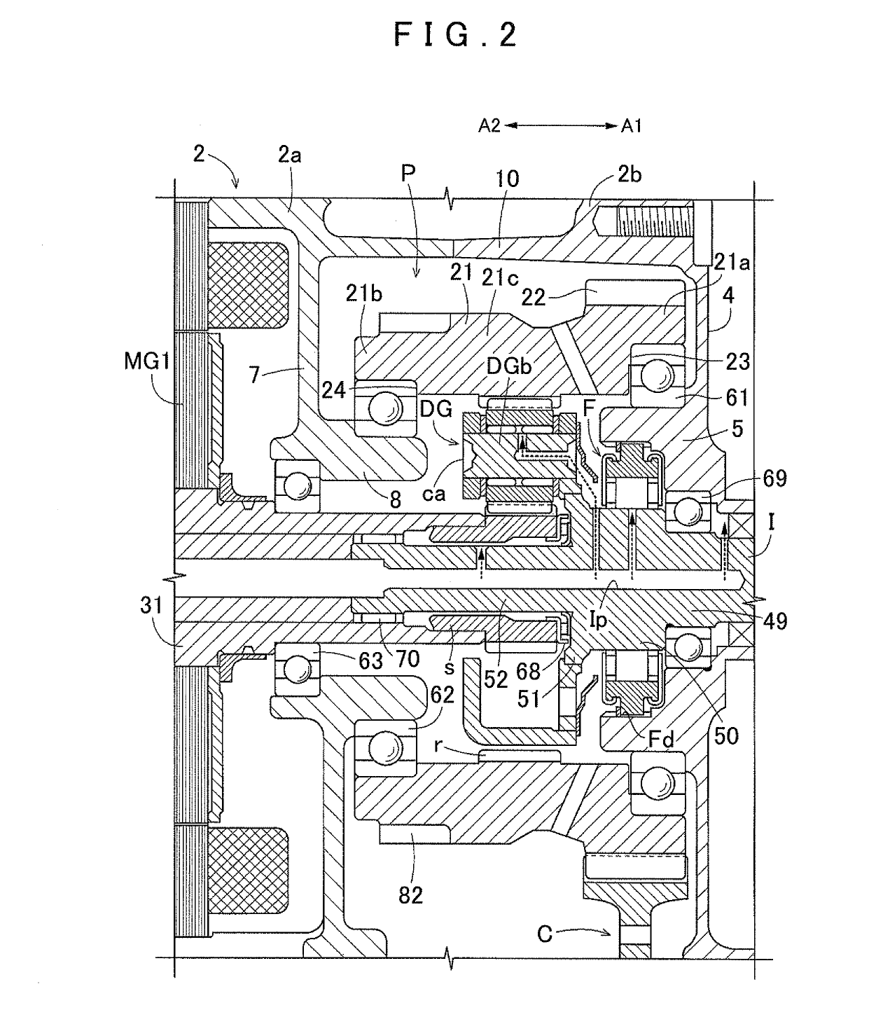

The mechanical configuration of each part of the vehicle drive device 1 according to the present embodiment will be described below. The input member I, the first rotating electrical machine MG1, the second rotating electrical machine MG2, the differential gear unit DG, the one-way clutch F, the counter gear mechanism C, and the output differential gear unit DF, which are described above, are accommodated in the case 2. In the present embodiment, as shown in FIG. 2, the case 2 is configured to have a case main body portion 2a and a cover portion 2b that is attached to an axial first direction A1 side (the right side in FIG. 2; the same applies to the following description) of the case main body portion 2a. The case main body portion 2a and the cover portion 2b are fastened and fixed together by using a fastening member such as a bolt.

The first rotating electrical machine MG1 and the second rotating electrical machine MG2 are mainly accommodated in the case main body portion 2a. The input member I, the differential gear unit DG, the distribution output member 21, the output gear 22, the counter gear mechanism C, and the output differential gear unit DF are mainly accommodated in an accommodating space P formed between the case main body portion 2a and the cover portion 2b. The case main body portion 2a includes a main body peripheral wall formed in an irregular cylindrical shape so as to cover at least the outer peripheral surfaces of the first rotating electrical machine MG1 and the second rotating electrical machine MG2, and a second support wall 7 that closes an opening on the axial first direction A1 side of the main body peripheral wall. The main body peripheral wall and the second support wall 7 are formed integrally. The cover portion 2b includes a cover peripheral wall 10 formed in an irregular cylindrical shape so as to cover at least the outer peripheral surfaces of the differential gear unit DG, the distribution output member 21, the output gear 22, the counter gear mechanism C, and the output differential gear unit DF, and a first support wall 4 that closes an opening on the axial first direction A1 side of the cover peripheral wall 10. The cover peripheral wall 10 and the first support wall 4 are formed integrally.

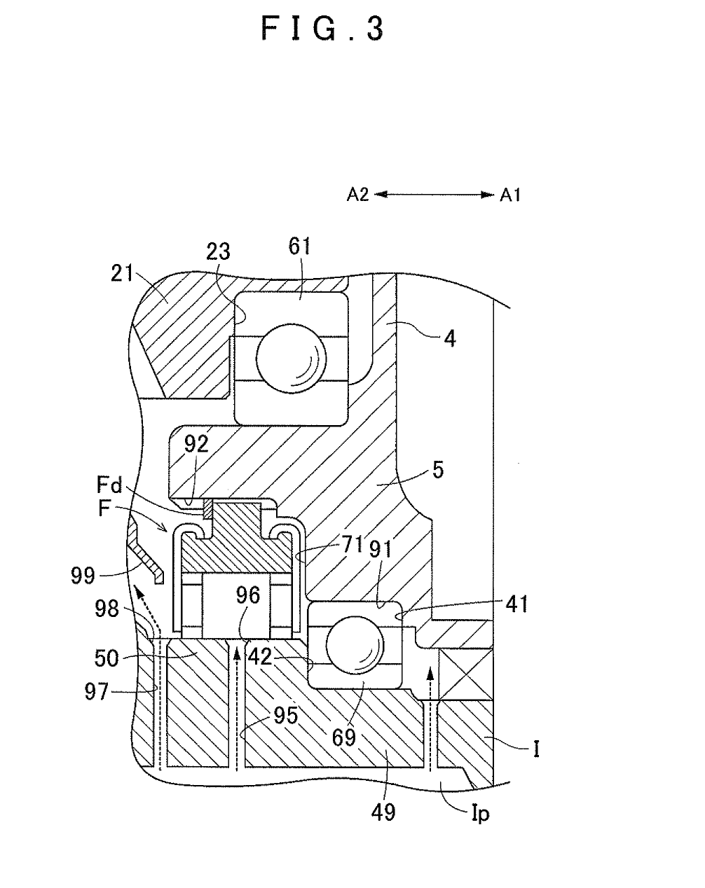

The first support wall 4 is shaped to extend at least in a radial direction, and in the present embodiment, extends in the radial direction and the circumferential direction. The first support wall 4 extends in the radial direction on the opposite side in an axial direction from the differential gear unit DG with respect to a first output bearing 61 described below. An axial through hole is formed in the first support wall 4. The input member 1, which is inserted through this through hole, extends through the first support wall 4 and is inserted in the case 2. The first support wall 4 includes a cylindrical (boss-shaped) first axially protruding portion 5 that is placed around the input member I so as to be separated from the input member I by a predetermined distance, and that protrudes toward the axial second direction A2 side (toward the differential gear unit DG side as the accommodating space P side as viewed from the first support wall 4, the left side in FIG. 2; the same applies to the following description). The first axially protruding portion 5 is formed integrally with the first support wall 4. As shown in FIG. 3, the first support wall 4 includes, at a position radially inward of the first axially protruding portion 5, a first opposing surface 41 that faces toward the axial second direction A2 side (toward the differential gear unit DG in the axial direction). The first opposing surface 41 is formed so as to contact an outer ring of an input support bearing 69 described below, and so as not to contact an inner ring of the input support bearing 69.

In the present embodiment, the first support wall 4 corresponds to the “support wall” in the present application.

In the present embodiment, the first axially protruding portion 5 has a stepped portion 71 in its inner peripheral surface. The stepped portion 71 is a portion of the inner peripheral surface of the first axially protruding portion 5, where the inner diameter of the first axially protruding portion 5 changes in a stepped manner. The inner peripheral surface of the first axially protruding portion 5 is formed so that the first axially protruding portion 5 has a larger inner diameter on the axial second direction A2 side with respect to the stepped portion 71 than on the axial first direction A1 side with respect to the stepped portion 71. Thus, the stepped portion 71 has a surface facing toward the axial second direction A2 side (toward the differential gear unit DG).

In the following description, the smaller-diameter region on the axial first direction A1 side in the inner peripheral surface of the first axially protruding portion 5 is referred to as the “first inner peripheral surface 91,” and the larger-diameter region on the axial second direction A2 side in the inner peripheral surface of the first axially protruding portion 5 is referred to as the “second inner peripheral surface 92.

As shown in FIG. 2, the second support wall 7 is shaped to extend at least in the radial direction, and in the present embodiment, extends in the radial direction and the circumferential direction. An axial through hole is formed in the second support wall 7. The first rotor shaft 31, which is inserted through this through hole, extends through the second support wall 7 and is coupled to the sun gear s of the differential gear unit DG in the accommodating space P. The second support wall 7 includes, around the first rotor shaft 31, a cylindrical (boss-shaped) second axially protruding portion 8 that protrudes in the axial first direction A1 (to the differential gear unit DG side as the accommodating space P side as viewed from the second support wall 7). The second axially protruding portion 8 is formed integrally with the second support wall 7. In the present embodiment, the first axially protruding portion 5 formed integrally with the first support wall 4 is placed so as to face the second axially protruding portion 8 formed integrally with the second support wall 7.

The input member 1 is a shaft member that inputs the torque of the internal combustion engine E to the vehicle drive device 1, and is coupled to the internal combustion engine E at its end on the axial first direction A1 side. The input member I is supported from radially outside by the first axially protruding portion 5 of the first support wall 4 so as to be rotatable via the input support bearing 69. In the present embodiment, the input member I has a smaller-diameter portion 49, a larger-diameter portion 50, a flange portion 51, and an insertion portion 52 sequentially from the axial first direction A1 side. The smaller-diameter portion 49 is a portion formed so as to have a smaller outer diameter than the larger-diameter portion 50 and the flange portion 51, which are described later. In the present embodiment, the first rotor shaft 31 of the first rotating electrical machine MG1 is formed in a pipe shape having therein an axial through hole. The insertion portion 52 is an end on the axial second direction A2 side of the input member I, and is a portion formed to be able to be inserted into the through hole formed in the first rotor shaft 31. At this time, the insertion portion 52 of the input member I is supported from radially outside by the first rotor shaft 31 so as to be rotatable via an insertion-portion bearing 70. In this example, the insertion-portion bearing 70 is a needle bearing.

The input member I has, on the axial second direction A2 side with respect to the first support wall 4, the flange portion 51 extending radially outward from the input member I. The flange portion 51 is formed integrally with the input member I. The flange portion 51 extends between the sun gear s coupled to the first rotor shaft 31 of first rotating electrical machine MG1 and the first axially protruding portion 5 of the first support wall 4, and is coupled to the carrier ea of the differential gear unit DG. The sun gear s is in contact with the axial second direction A2 side of the flange portion 51 with a second thrust bearing 68 interposed therebetween.

The input member I includes, on the axial first direction A1 side with respect to the flange portion 51, the larger-diameter portion 50 formed so as to have a larger outer diameter than the smaller-diameter portion 49. The larger-diameter portion 50 is formed to have a portion that overlaps the first axially protruding portion 5 as viewed in the radial direction. In the present embodiment, the larger-diameter portion 50 is continuously formed along the axial direction from the flange portion 51 to the boundary portion with the smaller-diameter portion 49. A stepped portion where the diameter of the outer peripheral surface of the input member I changes in a stepped manner is formed in the boundary portion between the larger-diameter portion 50 and the smaller-diameter portion 49, and this stepped portion allows an end face on the axial first direction A1 side of the larger-diameter portion 50 to serve as a second opposing surface 42 facing toward the axial first direction A1 side (toward the first support wall 4). In other words, the larger-diameter portion 50 includes the second opposing surface 42 facing toward the first support wall 4 in the axial direction. The second opposing surface 42 is formed substantially flat, and is in contact with a side surface on the axial second direction A2 side of the input support bearing 69. In the present embodiment, the larger-diameter portion 50 is formed integrally with the input member I, and functions as an inner race of the one-way clutch F.

The first rotor shaft 31 is a shaft that inputs the torque of the first rotating electrical machine MG1 to the sun gear s of the differential gear unit DG (or inputs the torque, transferred to the sun gear s, to the first rotating electrical machine MG1). As shown in FIG. 2, the first rotor shaft 31 is spline coupled, at its end on the axial first direction A1 side, to the sun gear s. The first rotor shaft 31 is supported from radially outside by the second axially protruding portion 8 of the second support wall 7 so as to be rotatable via a first rotor bearing 63.

The distribution output member 21 is placed radially outward of the sun gear s and the carrier ca so as to surround the sun gear s and the carrier ca. The distribution output member 21 is a cylindrical member placed coaxially with the input member I. In the present embodiment, the distribution output member 21 is formed to have such an axial length that the distribution output member 21 occupies substantially the entire accommodating space P in the axial direction. In the present embodiment, the distribution output member 21 has two inner-peripheral-surface stepped portions 23, 24 in its inner peripheral surface. The inner-peripheral-surface stepped portions 23, 24 are formed at a predetermined distance from both axial ends of the distribution output member 21, respectively. The inner-peripheral-surface stepped portions 23, 24 are portions where the inner diameter of the distribution output member 21 changes in a stepped manner. In end regions 21a, 21b on both sides, the distribution output member 21 is rotatably supported by the case 2 via the first output bearing 61 and a second output bearing 62. The end regions 21a, 21b are regions located on the axial ends of the inner-peripheral-surface stepped portions 23, 24, respectively, and a central region 21c is an axially central region interposed between the inner-peripheral-surface stepped portions 23, 24. The central region 21c is formed to have an inner diameter smaller than the inner diameters of the end regions 21a, 21b.

The ring gear r of the differential gear unit DG is formed integrally with the distribution output member 21 on the inner peripheral surface of the distribution output member 21. In the present embodiment, the ring gear r is formed on the inner peripheral surface of the central region 21 c of the distribution output member 21. Thus, the entire differential gear unit DG is placed radially inward of the distribution output member 21 so as to overlap the distribution output member 21 as viewed in the radial direction. The axial length of the vehicle drive device 1 is reduced by using such an arrangement configuration and placing the entire differential gear unit DG within a range of the length that is occupied by the distribution output member 21 in the axial direction.

The distribution output member 21 is supported at a plurality of positions (in the present embodiment, two positions) in the axial direction so as to be rotatable with respect to the case 2. In the present embodiment, the distribution output member 21 is supported on both axial sides of the differential gear unit DG so as to be rotatable with respect to the case 2 via the first output bearing 61 and the second output bearing 62 that are placed radially inward of the distribution output member 21. More specifically, the distribution output member 21 is configured so that the first output bearing 61 and the second output bearing 62 support the end regions 21a, 21b formed on both sides in the axial direction and having a larger diameter than the central region 21 c. In the end region 21a on the axial first direction A1 side, the distribution output member 21 is supported from radially inward of by the first output bearing 61 placed between the inner peripheral surface of the end region 21a and the outer peripheral surface of the first axially protruding portion 5 of the first support wall 4, so that the distribution output member 21 is rotatable with respect to the case 2. In the end region 21b on the axial second direction A2 side, the distribution output member 21 is supported from radially inward of by the second output bearing 62 placed between the inner peripheral surface of the end region 21b and the outer peripheral surface of the second axially protruding portion 8 of the second support wall 7, so that the distribution output member 21 is rotatable with respect to the case 2.

At both axial ends of the distribution output member 21, the distribution output member 21 is supported from both axial sides via the first output bearing 61 and the second output bearing 62, so that the axial position of the distribution output member 21 is restricted. More specifically, the inner-peripheral-surface stepped portion 23 formed on the axial first direction A1 side of the distribution output member 21 is supported from the axial first direction A1 side by the first support wall 4 via the first output bearing 61. The inner-peripheral-surface stepped portion 24 formed on the axial second direction A2 side of the distribution output member 21 is supported from the axial second direction A2 side by the second support wall 7 via the second output bearing 62.

In the present embodiment, the first output bearing 61, which is one of these two output bearings 61, 62, is placed so that at least a part of the first output bearing 61 overlaps the one-way clutch F as viewed in the radial direction. Specifically, the first output bearing 61 is placed so that a part on the axial second direction A2 side of the first output bearing 61 that is placed radially outward of the first axially protruding portion 5 so as to be in contact therewith overlaps a part on the axial first direction A1 side of the one-way clutch F that is placed radially inward of the first axially protruding portion 5, as viewed in the radial direction. That is, the first output bearing 61, the first axially protruding portion 5, and the one-way clutch F are arranged so as to overlap each other as viewed in the radial direction. The one-way clutch F is placed so that the entire one-way clutch F is located on the axial second direction A2 side with respect to an end face on the axial first direction A1 side of the first output bearing 61. This arrangement prevents an increase in axial length of the vehicle drive device 1, which is caused by providing the one-way clutch F.

In the present embodiment, the first output bearing 61 corresponds to the “support bearing” in the present application, and the two output bearings 61, 62 correspond to the “pair of distribution support bearings.”

The output gear 22 and a parking gear 82 are integrally formed on the outer peripheral surface of the distribution output member 21. In the present embodiment, the output gear 22 is placed near the end on the axial first direction A1 side (the internal combustion engine E side) of the distribution output member 21. This allows the configurations such as the counter gear mechanism C, the second rotating electrical machine MG2, and the output differential gear unit DF, which are placed on the downstream side of a power transmission path with respect to the output gear 22, to be placed near the axial first direction A1 side (the internal combustion engine E side). Note that in such position setting of the output gear 22, the output gear 22 is placed to overlap, as viewed in the axial direction, the first output bearing 61 that is also placed at the end on the axial first direction A1 side but radially inward of the distribution output member 21. Moreover, in the present embodiment, the output gear 22 is placed to overlap the one-way clutch F as well, as viewed in the radial direction. Thus, the axial length of the space where the first output bearing 61, the output gear 22, and the one-way clutch F are arranged can be reduced as compared to the case where the first output bearing 61, the output gear 22, and the one-way clutch F are arranged side by side in the axial direction.

In the present embodiment, the parking gear 82 is placed near the end on the axial second direction A2 side (the second support wall 7 side) on the outer peripheral surface of the distribution output member 21. The parking gear 82 is placed to overlap, as viewed in the radial direction, the second output bearing 62 that is also placed at the end on the axial second direction A2 side but radially inward of the distribution output member 21.

The one-way clutch F is provided so as to restrict negative rotation of the carrier ca of the differential gear unit DO. In the present embodiment, the one-way clutch F is placed radially outward of the input member I so as to restrict negative rotation of the input member I drivingly coupled to the carrier ca. In the present embodiment, the larger-diameter portion 50 of the input member I serves as the inner race of the one-way clutch F, and an outer race of the one-way clutch F is attached to the second inner peripheral surface 92 of the first axially protruding portion 5 of the case 2. The outer race fits on splines formed in the second inner peripheral surface 92, so that the circumferential and radial positions of the outer race are restricted. The axial position of the outer race is restricted by a ring member Fd. The one-way clutch F is placed so as to overlap the input support bearing 69 as viewed in the axial directional. Specifically, a part of the one-way clutch F overlaps the input support bearing 69 as viewed in the axial directional.

More specifically, the one-way clutch F includes a sliding portion Fb between the large-diameter portion 50 of the input member I as the inner race and the second inner peripheral surface 92 of the first axially protruding portion 5 as the outer race. The sliding portion Fb includes, at a plurality of positions in the circumferential direction, a lock member that restricts relative rotation between the outer race and the inner race. That is, the sliding portion Fb includes a sliding part between the inner race and the outer race and a sliding part between the inner race or the outer race and the lock member. In the present embodiment, the lock member is configured to allow the outer race and the inner race to rotate relative to each other during positive rotation of the input member I. Thus, the positive rotation of the input member I as the inner race is not obstructed. On the other hand, the relative rotation between the outer race and the inner race is restricted during negative rotation of the input member I. That is, the negative rotation of the input member I as the inner race is restricted.

For example, a known sprag type or roller type member can be used as such a lock member. In the sprag type lock member, when relative rotation between the outer race and the inner race is in a predetermined direction, sprags are lifted to generate a large friction force between the outer race and the inner race, thereby restricting the relative rotation between the outer race and the inner race. The roller type lock member has a configuration in which rollers are accommodated in wedge-shaped spaces formed between the outer race and the inner race, and each roller is biased by a spring member toward the wider side of the wedge-shaped space. In the roller type lock member, when relative rotation between the outer race and the inner race is in a predetermined direction, each roller moves to the narrower side of the wedge-shaped space to generate a large friction force between the outer race and the inner race, thereby restricting the relative rotation between the outer race and the inner race.

The input support bearing 69 is placed in contact with both the input member I and the first axially protruding portion 5 of the case 2, and rotatably supports the input member 1. Specifically, as shown in FIG. 3, the input support bearing 69 is placed in contact with the outer peripheral surface of the smaller-diameter portion 49 of the input member I and with the first inner peripheral surface 91 of the first axially protruding portion 5. In the present embodiment, a ball bearing is used as the input support bearing 69. The input support bearing 69 is placed in contact with both the larger-diameter portion 50 of the input member I and the first support wall 4. Specifically, an end face on the axial second direction A2 side of the inner ring of the input support bearing 69 is in contact with the second opposing surface 42 as the end face on the axial first direction A1 side of the larger-diameter portion 50, and an end face on the axial first direction A1 side of the outer ring of the input support bearing 69 is in contact with the first opposing surface 41 of the first support wall 4. With this configuration, load (thrust load) that is applied in the axial direction to the carrier ca of the differential gear unit DG is transferred to the input member I via the flange portion 51, and is also supported by the first support wall 4 via the input support bearing 69. That is, this configuration allows the input member I to be supported in the radial and axial directions by the input support bearing 69.

1-3. Configuration of Oil Supply Passage

Note that in the present embodiment, an internal oil passage Ip in which oil supplied from an oil pump, not shown, flows is formed in the axial direction in the input member I. A first communication passage 95 communicating with the internal oil passage Ip and extending in the radial direction is also formed in the input member I. The first communication passage 95 communicates with a first opening portion 96 that opens in the outer peripheral surface of the input member I at a position overlapping the sliding portion Fb of the one-way clutch F in the axial direction. This allows the oil supplied from the internal oil passage Ip of the input member I to be supplied to the sliding portion Fb of the one-way clutch F via the first communication passage 95 and the first opening portion 96,

A second communication passage 97 communicating with the internal oil passage Ip and extending in the radial direction is formed in the input member I at a different axial position from the first communication passage 95. Specifically, the second communication passage 97 is formed on the axial second direction A2 side (the differential gear unit DG side in the axial direction) with respect to the first communication passage 95. The second communication passage 97 has a second opening portion 98 that opens in the outer peripheral surface of the input member I. The second opening portion 98 is placed at a position overlapping, as viewed in the radial direction, an oil collecting portion 99 provided in the differential gear unit DG. The oil collecting portion 99 communicates with a sliding portion DGb of each gear of the differential gear unit DG via an oil passage formed in a carrier shaft of the carrier ca of the differential gear unit DG. This allows the oil supplied from the internal oil passage Ip of the input member I to be supplied to the sliding portion DGb of each gear of the differential gear unit DG via the second communication passage 97, the second opening portion 98, the oil collecting portion 99, and the oil passage in the carrier shaft.

As described above, in the present embodiment, the first communication passage 95 and the second communication passage 97 are formed in the input member I, whereby oil can be supplied to both the sliding portion Fb of the one-way clutch F and the sliding portion DGb of each gear of the differential gear unit DG.

### 2. Second Embodiment

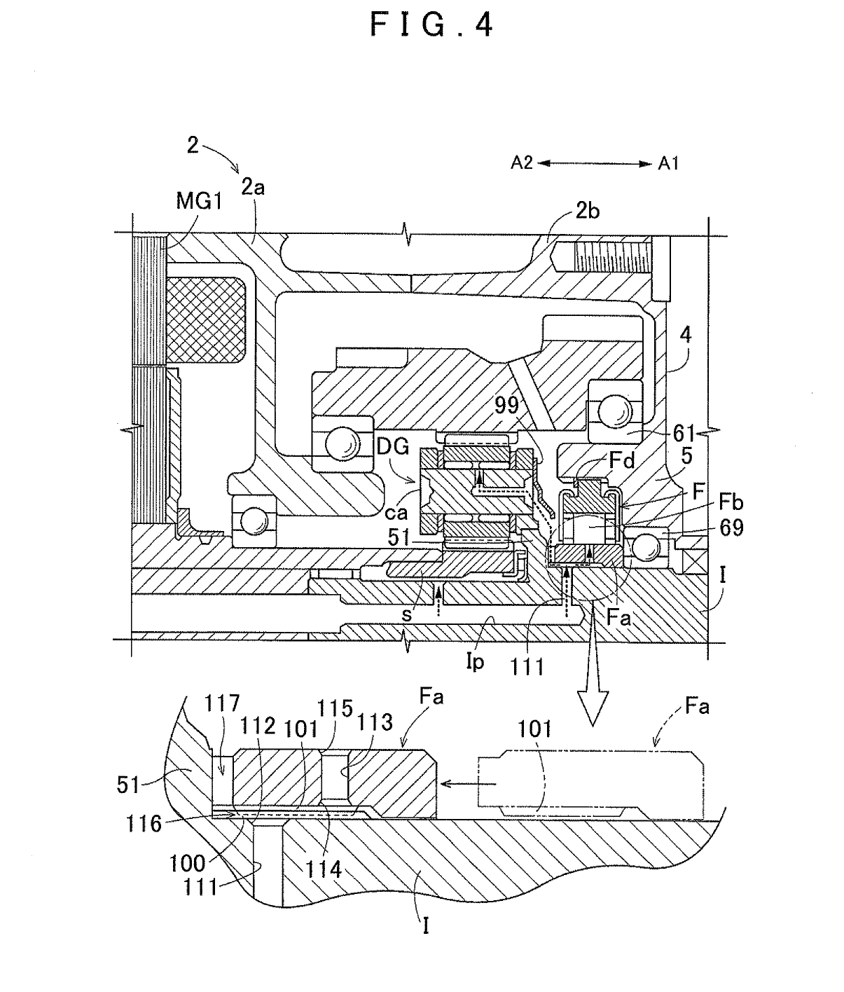

A second embodiment of the present invention will be described below with reference to FIG. 4. The present embodiment is different from the first embodiment in that the inner race of the one-way clutch F is not formed integrally with the input member I and is formed as a separate member from the input member I. The present embodiment is also different from the first embodiment in the configuration of the oil supply passage that supplies oil lubricating the one-way clutch F and the differential gear unit DG. The vehicle drive device 1 according to the present embodiment will be described below mainly with respect to the differences from the first embodiment. The present embodiment is similar to the first embodiment in those points that are not particularly mentioned.

In the present embodiment, the input member I has no large-diameter portion 50, and the input member I has a substantially uniform outer peripheral surface on the axial first direction A1 side with respect to the flange portion 51. A spline tooth 100 is formed in a portion of the outer peripheral surface of the input member I, which adjoins the flange portion 51 on the axial first direction A1 side. The spline tooth 100 is formed in a range from a position in contact with an end face on the axial first direction Al side in the axial direction of the flange portion 51 to a position on the axial first direction A1 side with respect to an axial central portion of the one-way clutch F.

2-1. Configuration of Inner Race

As shown in FIG. 4, an inner race Fa of the one-way clutch F according to the present embodiment is formed by a cylindrical member separate from the input member I. The inner race Fa is spline fitted on the outer peripheral surface of the input member I, and thus is attached so as to rotate together with the input member I. The fitting portion between the input member I and the inner race Fa is formed by the spline tooth 100 provided on the outer peripheral surface of the input member I and a spline groove 101 formed in the inner peripheral surface of the inner race Fa so as to be fitted on the spline tooth 100. The spline groove 101 is formed along a predetermined length from the end on the axial second direction A2 side in the inner peripheral surface of the inner race Fa. Specifically, the spline groove 101 is formed to extend from the end on the axial second direction A2 side in the inner peripheral surface of the inner race Fa to a position that overlaps at least the sliding portion Fb of the one-way clutch F as viewed in the radial direction. In this example, the spline groove 101 is formed in a range from the end on the axial second direction A2 side of the inner peripheral surface of the inner race Fa to a position on the axial first direction A1 side with respect to an axial central position of the sliding portion Fb.

On the other hand, the inner peripheral surface of the inner race Fa is formed so as to be in contact with the outer peripheral surface of the input member I in a region of a predetermined axial length from the end on the axial first direction A1 side (a region where no spline groove 101 is formed). With this configuration, the circumferential position of the inner race Fa is restricted by spline fitting on the input member I, and the radial position of the inner race Fa is restricted by contact between the portion where no spline groove 101 is formed and the outer peripheral surface of the input member I.

In the present embodiment, when the inner race Fa is spline fitted on the input member I, an end face on the axial second direction A2 side (the differential gear unit DG side) in the axial direction of the inner race Fa contacts the end face (the outer peripheral surface of the input member I) on the axial first direction A1 side of the flange portion 51 of the input member I. One or more radial grooves 117 extending in the radial direction are formed in the end face on the axial second direction A2 side of the inner race Fa. The radial groove 117 is formed so as to provide communication between regions radially inward of and outside the inner race Fa. Thus, a radially inner end portion of the radial groove 117 communicates with a differential gear unit-side gap 116, which is a gap between the inner peripheral surface of the end on the axial second direction A2 side (the differential gear unit DG side) of in the axial direction of the inner race Fa and the outer peripheral surface of the input member 1.

2-2. Configuration of Oil Supply Passage

In the present embodiment, the internal oil passage Ip, which is formed in the axial direction in the input member I, is formed to extend in the axial direction from the end on the axial second direction A2 side of the input member I at least to a position overlapping the spline tooth 100 as viewed in the radial direction. The internal oil passage Ip communicates with an outer peripheral opening portion 112 that opens in the outer peripheral surface of the input member I. The outer peripheral opening portion 112 is placed at a position that overlaps the inner race Fa, as viewed in the radial direction, in the state in which the inner race Fa is spline fitted on the input member I. In this example, the outer peripheral opening portion 112 is placed on the axial second direction A2 side with respect to the axial central position of the sliding portion Fb of the one-way clutch F in the state in which the inner race Fa is spline fitted on the input member I. In the present embodiment, a common oil passage 111 extending perpendicularly to the internal oil passage Ip is formed so as to communicate with an end on the axial first direction A 1 side of the internal oil passage Ip. This common oil passage 111 allows the internal oil passage Ip to communicate with the outer peripheral opening portion 112. With this configuration, oil is supplied from the internal oil passage Ip to the outer peripheral opening portion 112 through the common oil passage 111.

An inner-race internal oil passage 113 is formed in the inner race Fa at a position that overlaps the sliding portion Fb as viewed in the radial direction. The inner-race internal oil passage 113 is formed to radially extend through the inner race Fa on the axial first direction A1 side (a side opposite to a side where the differential gear unit-side gap 116 is formed in the axial direction) with respect to the outer peripheral opening portion 112. The inner-race internal oil passage 113 has an inner-race inner peripheral surface opening portion 114 that opens in a region where the spline groove 101 is formed in the inner peripheral surface of the inner race Fa, and an inner-race outer peripheral surface opening portion 115 that opens in a region contacting the sliding portion Fb in the outer peripheral surface of the inner race Fa. In this example, the inner-race internal oil passage 113 is formed as a through hole radially extending through the inner race Fa.

With this configuration, the inner-race internal oil passage 113 serves as an oil supply portion to the sliding portion Fb, and the differential gear unit-side gap 116 serves as an oil supply portion to the differential gear unit DG Specifically, the oil supplied from the internal oil passage Ip to the outer peripheral opening portion 112 through the common oil passage 111 is supplied to the inner-race inner peripheral surface opening portion 114 and the differential gear unit-side gap 116 through clearance provided between spline tooth 100 and spline groove 101. The oil supplied to the inner-race inner peripheral surface opening portion 114 flows through the inner-race internal oil passage 113, and is supplied from the inner-race outer peripheral surface opening portion 115 to the sliding portion Fb of the one-way clutch F. On the other hand, the oil supplied to the differential gear unit-side gap 116 is supplied from the differential gear unit-side gap 116 to the radial groove 117 extending radially outward, and is supplied from an opening at a radial outer end of the radial groove 117 to the oil collecting portion 99 of the differential gear unit DO provided radially outward of the opening, due to a centrifugal force that is generated during rotation of the input member I. The oil supplied to the oil collecting portion 99 is used to lubricate the differential gear unit DG. In this manner, in the present embodiment, oil can be supplied to both the sliding portion Fb of the one-way clutch F and the differential gear unit DG by merely forming the common oil passage 111 in the input member I.

Note that in the present embodiment, it is preferable that the outer peripheral opening portion 112 be formed at an intermediate position between the inner-race internal oil passage 113 and the differential gear unit-side gap 116 and the radial groove 117 in the axial direction, in the state in which the inner race Fa is spline fitted on the input member 1. This configuration allows oil to be equally supplied to the inner-race internal oil passage 113 and the differential gear unit-side gap 116. Accordingly, the oil can be suitably supplied to both the sliding portion Fb of the one-way clutch F and the differential gear unit DG.

### Other Embodiments

Lastly, other embodiments of the vehicle drive device of the present invention will be described. Note that the configuration of each embodiment described below is not limited to the configuration that is used by itself, but may be applied in combination with the configurations of the other embodiments as long as no inconsistency arises.

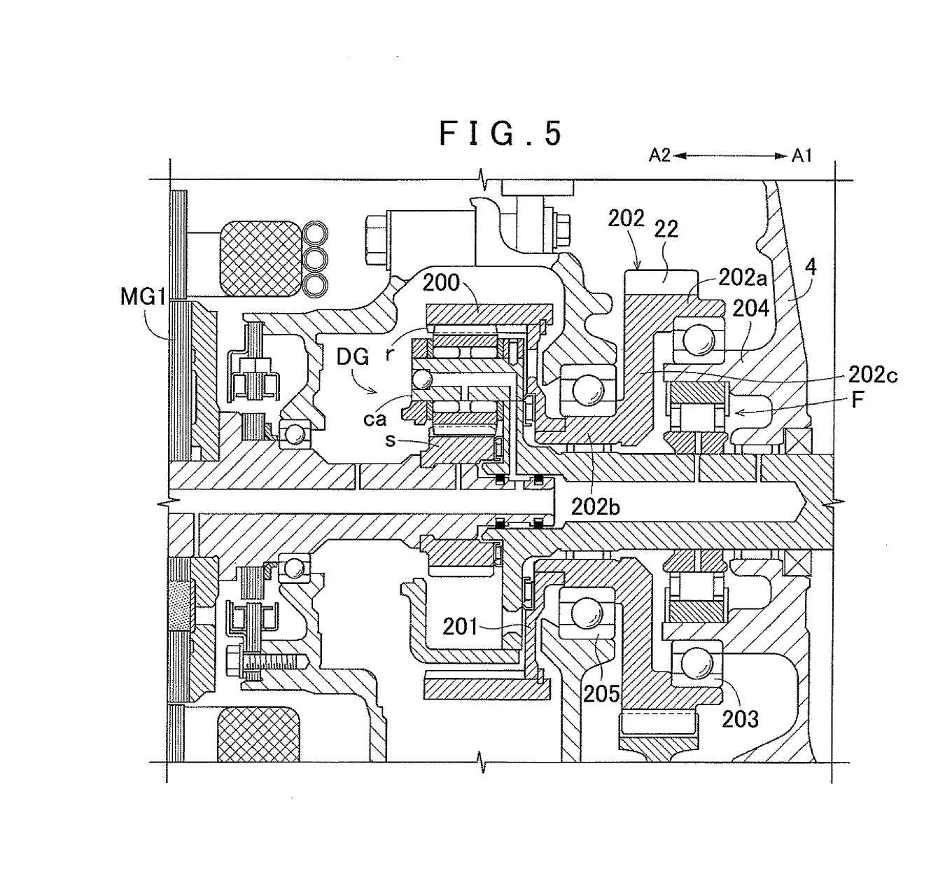

(1) The above embodiments are described with respect to an example in which the distribution output member 21 is formed in a cylindrical shape, and the ring gear r and the output gear 22 are formed integrally. However, embodiments of the present invention are not limited to this. That is, it is also one of preferred embodiments of the present invention that the distribution output member 21 be formed by a plurality of members and the overall shape of the distribution output member 21 be not cylindrical. For example, as shown in FIG. 5, it is also one of preferred embodiments of the present invention that the distribution output member 21 be configured to have a cylindrical member 200 having on its inner peripheral surface the ring gear r of the differential gear unit DG, an annular disc-shaped coupling member 201 extending in the radial direction and the circumferential direction and coupled to an end on the axial first direction A1 side of the cylindrical member 200, and a coupling output member 202 coupled to an inner peripheral end of the coupling member 201. In this example, the coupling output member 202 is a stepped cylindrical member having a smaller-diameter cylindrical portion 202b that is coupled to the coupling member 201, a larger-diameter cylindrical portion 202a having the output gear 22 formed integrally on its outer peripheral surface, and a coupling portion 202c extending in the radial direction and the circumferential direction and coupling the smaller-diameter cylindrical portion 202b and the larger-diameter cylindrical portion 202a together. The smaller-diameter cylindrical portion 202b is placed so as to surround the radially outer side of the input member I, and is rotatably supported from radially outside by a second output bearing 205 that contacts the outer peripheral surface of the smaller-diameter cylindrical portion 202b. The larger-diameter cylindrical portion 202a is rotatably supported from radially inward of by a first output bearing 203 that contacts both the inner peripheral surface of the larger-diameter cylindrical portion 202a and an axially protruding portion 204 formed in the first support wall 4. The one-way clutch F is placed radially inward of the first output bearing 203 at a position overlapping the first output bearing 203 as viewed in the radial direction. In the example of FIG. 5, the one-way clutch F is placed so that an end face on the axial first direction A1 side of the first output bearing 203 is located at the same position in the axial direction as an end face on the axial first direction A1 side of the one-way clutch F. In this example, the first output bearing 203 corresponds to the “support bearing” in the present application. Like the above embodiment, this configuration can also suppress an increase in overall axial length of the vehicle drive device 1, which is caused by adding the one-way clutch F.

(2) The above embodiments are described with respect to an example in which the one-way clutch F is placed on the axial first direction A1 side with respect to the differential gear unit DG. However, embodiments of the present invention are not limited to this. That is, it is also one of preferred embodiments of the present invention that the one-way clutch F be placed on the axial second direction A2 side with respect to the differential gear unit DO In this case, for example, in the first embodiment, the carrier ca of the differential gear unit DG may include a member extending toward the axial second direction A2 side in a radial region between the second axially protruding portion 8 and the first rotor shaft 31, so that the one-way clutch F is placed in contact with the member and the second radially protruding portion 8, at a position overlapping the second output bearing 62 as viewed in the radial direction. In this case, as shown in FIG. 2, it is preferable that the parking gear 82 be provided near the end on the axial second direction A2 side of the outer peripheral surface of the distribution output member 21, and that the parking gear 82, the second output bearing 62, and the one-way clutch F overlap each other as viewed in the radial direction. This configuration can reduce the axial length of the space in which the parking gear 82, the second output bearing 62, and the one-way clutch F are arranged, as compared to the case where the parking gear 82, the second output bearing 62, and the one-way clutch F are arranged side by side in the axial direction.

(3) The above embodiments are described with respect to an example in which the entire one-way clutch F is placed on the axial second direction A2 side (the differential gear unit DG side) with respect to the end face on the axial first direction A1 side of the first output bearing (61, 203). However, embodiments of the present invention are not limited to this. That is, it is also one of preferred embodiments of the present invention that a part of the one-way clutch F is placed on the axial first direction Al side (the opposite side from the differential gear unit DG) with respect to an end face on the axial first direction A1 side of the support bearing.

(4) The second embodiment is described with respect to an example in which the inner race of the one-way clutch F is formed by a separate member from the input member I, and the common oil passage 111 is formed in the input member I as a common oil passage that supplies oil to the sliding portion Fb of the one-way clutch F and the differential gear unit DG. However, embodiments of the present invention are not limited to this. That is, it is also one of preferred embodiments of the present invention to form the inner race of the one-way clutch F by a separate member from the input member I and to separately provide an oil passage that supplies oil to the sliding portion Fb of the one-way clutch F and an oil passage that supplies oil to the differential gear unit DG.

(5) The first and second embodiments are described with respect to an example in which the input support bearing 69 is placed in an axial region between the first opposing surface 41 and the second opposing surface 42 so as to be in contact with both the first opposing surface 41 and the second opposing surface 42, and supports the input member I in the radial direction and the axial direction. However, embodiments of the present invention are not limited to this. That is, it is also one of preferred embodiments of the present invention that the input support bearing be placed between the input member I and the support wall and be placed so as to support the input member I only in the radial direction. In this case, for example, it is preferable that the input member I be supported in the axial direction by a thrust bearing provided at a different position from the input support bearing.

A vehicle drive device can be preferably used which includes an input member drivingly coupled to a drive output member of an internal combustion engine, an output member drivingly coupled to wheels, a rotating electrical machine, a distribution output member drivingly coupled to the output member, and a differential gear unit that distributes and transfers a torque, transferred to the input member, to the rotating electrical machine and the distribution output member.

What is claimed is:

1. A vehicle drive device, comprising: an input member drivingly coupled to a drive output member of an internal combustion engine that rotates in a positive direction;
an output member drivingly coupled to wheels; a rotating electrical machine; a distribution output member drivingly coupled to the output member; and a differential gear unit that distributes and transfers a torque, transferred to the input member, to the rotating electrical machine and the distribution output member, wherein:
the distribution output member is placed coaxially with the input member, and is supported in a radial direction by a support bearing so as to be capable of rotating;
rotation of the input member in a negative direction is restricted by a one-way clutch;
the one-way clutch is placed radially inward of the support bearing; and
at least a part of the one-way clutch is placed so as to overlap the support bearing as viewed in the radial direction.

2. The vehicle drive device according to claim 1, wherein:
the distribution output member is formed in a cylindrical shape;
the entire differential gear unit is placed radially inward of the distribution output member so as to overlap the distribution output member as viewed in the radial direction;
a pair of distribution support bearings are provided which are placed radially inward of the distribution output member on both sides in an axial direction with respect to the differential gear unit, and which support the distribution output member from radially inward of so as to be capable of rotating; and
one of the pair of distribution support bearings is the support bearing.

3. The vehicle drive device according to claim 1, further comprising:
a support wall extending in the radial direction on an opposite side in the axial direction from the differential gear unit with respect to the support bearing; and
an input support bearing that supports the input member from radially outside so as to be capable of rotating, wherein
the support wall includes a first opposing surface that faces toward the differential gear unit in the axial direction,
an inner race of the one-way clutch includes a second opposing surface that faces toward the support wall in the axial direction, and
the input support bearing is placed between the first opposing surface and the second opposing surface in the axial direction so as to be in contact with both the first opposing surface and the second opposing surface.

4. The vehicle drive device according to claim 1, wherein
the inner race of the one-way clutch is formed integrally with the input member.

5. The vehicle drive device according to claim 1, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

6. The vehicle drive device according to claim 2, further comprising:
a support wall extending in the radial direction on an opposite side in the axial direction from the differential gear unit with respect to the support bearing; and
an input support bearing that supports the input member from radially outside so as to be capable of rotating, wherein
the support wall includes a first opposing surface that faces toward the differential gear unit in the axial direction,
an inner race of the one-way clutch includes a second opposing surface that faces toward the support wall in the axial direction, and
the input support bearing is placed between the first opposing surface and the second opposing surface in the axial direction so as to be in contact with both the first opposing surface and the second opposing surface.

7. The vehicle drive device according to claim 6, wherein
the inner race of the one-way clutch is formed integrally with the input member.

8. The vehicle drive device according to claim 7, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

9. The vehicle drive device according to claim 2, wherein
the inner race of the one-way clutch is formed integrally with the input member.

10. The vehicle drive device according to claim 3, wherein
the inner race of the one-way clutch is formed integrally with the input member.

11. The vehicle drive device according to claim 2, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

12. The vehicle drive device according to claim 3, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

13. The vehicle drive device according to claim 6, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

14. The vehicle drive device according to claim 4, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

15. The vehicle drive device according to claim 9, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.

16. The vehicle drive device according to claim 10, wherein
the inner race of the one-way clutch is spline fitted on an outer peripheral surface of the input member,
the input member includes an internal oil passage formed in the input member, and an outer peripheral opening that communicates with the internal oil passage and that opens in the outer peripheral surface of the input member,
the outer peripheral opening is placed at a position overlapping the inner race as viewed in the radial direction,
a differential gear unit-side gap, which is a gap between an inner peripheral surface of an end on a side where the differential gear unit is formed in the axial direction of the inner race and the outer peripheral surface of the input member serves as an oil supply portion to the differential gear unit, and
an oil passage that extends through the inner race in the radial direction on an opposite side in the axial direction from the differential gear unit-side gap with respect to the outer peripheral opening serves as an oil supply portion to a sliding portion of the one-way clutch.
